(19) United States
(12) Patent Application Publication
(10) Pub. No.: US 2006/0005672 A1
(43) Pub. Date: Jan. 12, 2006

(54) Blades, saws, and methods for cutting microfeature workpieces

(76) Inventors: Gregory M. Chapman, Meridian, ID (US); Steven W. Heppler, Boise, ID (US)

Correspondence Address: PERKINS COIE LLP;PATENT-SEA, P.O. BOX 1247, SEATTLE, WA, 98111-1247, US

(21) Appl. No.: 10/886,825

(22) Filed: Jul. 7, 2004

(51) Int. Cl. B26D 1/00

(52) U.S. Cl. 83/13; 83/492

(57) ABSTRACT

Blades, saws, and methods for cutting microfeature workpieces are disclosed herein. In one embodiment, a saw includes a shaft for attachment to a spindle, an annular blade coupled to the shaft, and a support member coupled to the shaft and juxtaposed to the annular blade. The blade has a first thickness at a first diameter and a second thickness at a second diameter. The second thickness is different than the first thickness and sized to cut the microfeature workpiece. For example, the first thickness can be greater than the second thickness, and the second diameter can be greater than the first diameter.

### TECHNICAL FIELD

The present invention is related to blades, saws, and methods for cutting microfeature workpieces.

### BACKGROUND

Conventional microelectronic devices are manufactured for specific performance characteristics required for use in a wide range of electronic equipment. A die-level packaged microelectronic device can include a die, an interposer substrate or lead frame attached to the die, and a molded casing around the die. The die generally has an integrated circuit and a plurality of bond-pads coupled to the integrated circuit. The bond-pads are coupled to terminals on the interposer substrate or lead frame. The interposer substrate can also include ball-pads coupled to the terminals by conductive traces in a dielectric material. A plurality of solder balls can be attached to corresponding ball-pads to construct a “ball-grid” array. Packaged microelectronic devices with ball-grid arrays are generally higher grade packages that have lower profiles and higher pin counts than conventional chip packages that use a lead frame.

Die-level packaged microelectronic devices are typically made by (a) forming a plurality of dies on a semiconductor wafer, (b) cutting the wafer to singulate the dies, (c) attaching individual dies to corresponding interposer substrates, (d) wire-bonding the bond-pads to the terminals of the interposer substrate, and (e) encapsulating the dies with a molding compound. Mounting individual dies to individual interposer substrates is time consuming and expensive. Therefore, packaging processes have become a significant factor in producing semiconductor and other microelectronic devices.

Another process for packaging microelectronic devices is wafer-level packaging. In wafer-level packaging, a plurality of microelectronic dies are formed on a wafer and a redistribution layer is formed over the dies. The redistribution layer includes a dielectric layer, a plurality of ball-pad arrays on the dielectric layer, and a plurality of traces coupled to individual ball-pads of the ball-pad arrays. Each ball-pad array is arranged over a corresponding microelectronic die, and the traces couple the ball-pads in each array to corresponding bond-pads on the die. After forming the redistribution layer on the wafer, a stenciling machine deposits discrete blocks of solder paste onto the ball-pads of the redistribution layer. The solder paste is then reflowed to form solder balls or solder bumps on the ball-pads. After forming the solder balls on the ball-pads, the wafer is cut to singulate the dies. Microelectronic devices packaged at the wafer level can have high pin counts in a small area, but they are not as robust as devices packaged at the die level.

One drawback of conventional die-level and wafer-level packaging processes is that during singulation the cutting blades may break or wobble and, consequently, cut the wafer or workpiece out of specification. For example, FIG. 1 is a schematic side cross-sectional view of an annular blade 30 in accordance with the prior art cutting a workpiece 70 to singulate a plurality of dies 82. The annular blade 30 includes an inner portion 32 sandwiched between two support members 50 and an outer portion 34 projecting a distance W₁ from the inner portion 32. The outer portion 34 of the blade 30 is sized to project down between the dies 82 and through the workpiece 70. Because the exposed outer portion 34 of the blade 30 is relatively thin and unsupported, it may break or wobble during singulation. This can cause the workpiece 70 to be cut out of specification. Accordingly, there is a need for an improved blade for cutting workpieces to singulate dies.

### BRIEF DESCRIPTION OF THE DRAWINGS

FIG. 1 is a schematic side cross-sectional view of a blade in accordance with the prior art cutting a workpiece.

FIG. 2 is a schematic side cross-sectional view of a saw in accordance with one embodiment of the invention.

FIG. 3 is an isometric view of one of the annular blades of FIG. 2.

FIG. 4 is a schematic side cross-sectional view of the saw of FIG. 2 cutting a microfeature workpiece.

FIG. 5 is a schematic side cross-sectional view of the saw of FIG. 2 cutting a microfeature workpiece and forming features in the workpiece.

FIG. 6A is a schematic side cross-sectional view of a portion of an annular blade in accordance with another embodiment of the invention.

FIG. 6B is a schematic side cross-sectional view of a portion of an annular blade in accordance with another embodiment of the invention.

FIG. 6C is a schematic side cross-sectional view of a portion of an annular blade in accordance with another embodiment of the invention.

FIG. 6D is a schematic side cross-sectional view of a portion of an annular blade in accordance with another embodiment of the invention.

FIG. 6E is a schematic side cross-sectional view of a portion of an annular blade in accordance with another embodiment of the invention.

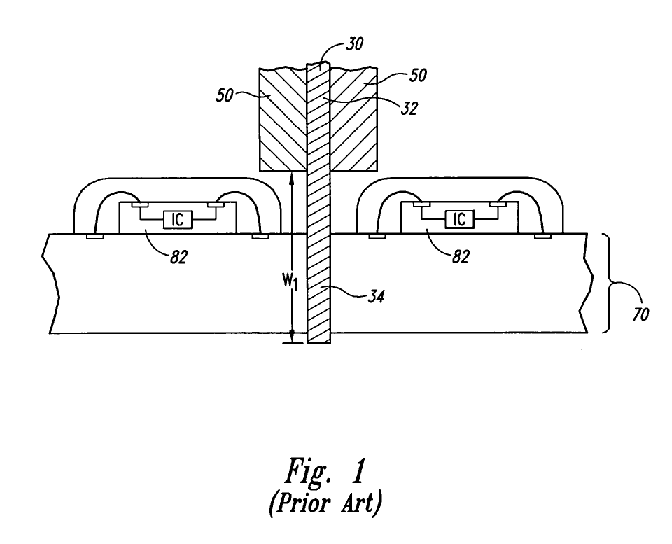

### DETAILED DESCRIPTION

A. Overview

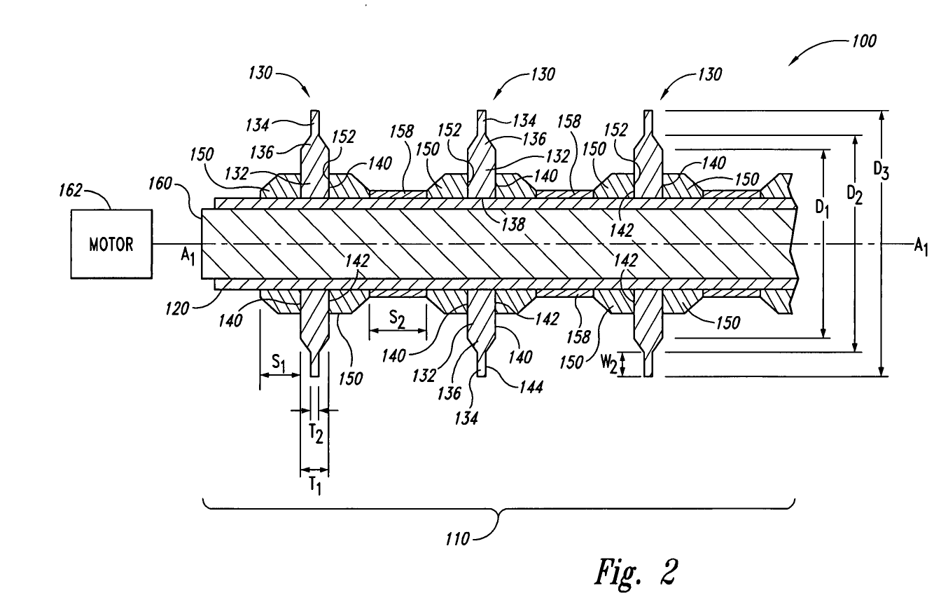

The following disclosure is directed to blades; saws, and methods for cutting microfeature workpieces. The term “microfeature workpiece” is used throughout to include substrates in and/or on which microelectronic devices, micromechanical devices, data storage elements, and other features are fabricated. For example, microfeature workpieces can be semiconductor wafers, glass substrates, insulated substrates, or many other types of substrates. The term “microfeature device” is used throughout to include microelectronic devices, micromechanical devices, data storage elements, read/write components, and other articles of manufacture. For example, microfeature devices include imagers, SIMM, DRAM, flash-memory, ASICS, processors, flip chips, ball-grid array chips, and other types of electronic devices or components. Several specific details of the invention are set forth in the following description and in FIGS. 2-6E to provide a thorough understanding of certain embodiments of the invention. One skilled in the art, however, will understand that the present invention may have additional embodiments and that the embodiments of the invention may be practiced without several of the specific features described below.

Several aspects of the invention are directed to saws for cutting microfeature workpieces. In one embodiment, a saw includes a shaft for attachment to a spindle, an annular blade coupled to the shaft, and a support member coupled to the shaft and juxtaposed to the annular blade. The blade has a first thickness at a first diameter and a second thickness at a second diameter. The second thickness is different than the first thickness and sized to cut a microfeature workpiece. For example, the first thickness can be greater than the second thickness, and the second diameter can be greater than the first diameter. The saw can further include a second annular blade coupled to the shaft. The second annular blade has a first thickness at a first diameter and a second thickness at a second diameter. The second thickness is different than the first thickness.

Another aspect of the invention is directed to blades for cutting a microfeature workpiece having a first microfeature device and a second microfeature device adjacent to the first microfeature device. In one embodiment, a blade includes an inner portion, an outer portion radially outward of the inner portion, and an intermediate portion between the inner and outer portions. The inner portion has a generally uniform first thickness and the outer portion has a second thickness less than the first thickness. The second thickness is sized to cut the microfeature workpiece between the first and second microfeature devices. The intermediate portion can include a beveled, convex, concave, and/or step-down portion.

Another aspect of the invention is directed to methods for cutting a microfeature workpiece. In one embodiment, a method includes providing a blade having a first surface and a second surface opposite the first surface. The first surface has an interior region and a perimeter region noncoplanar with the interior region, and the second surface has an interior region and a perimeter region noncoplanar with the interior region. The method further includes moving the blade relative to the microfeature workpiece to cut the workpiece. As the blade cuts the workpiece, the intermediate portion can form a feature in the workpiece.

B. Embodiments of Saws with Blades for Cutting Microfeature Workpieces

FIG. 2 is a schematic side cross-sectional view of a saw 100 for cutting microfeature workpieces in accordance with one embodiment of the invention. The illustrated saw 100 includes a blade assembly 110, a spindle 160 on which the blade assembly 110 is mounted, and a motor 162 operably coupled to the spindle 160. The motor 162 drives the spindle 160, which in turn rotates the blade assembly 110 about an axis A₁ to singulate or otherwise cut microfeature workpieces, as described in detail below.

The illustrated blade assembly 110 includes a hollow shaft 120, a plurality of annular blades 130 attached to the shaft 120, and a plurality of annular support members 150 attached to the shaft 120 between the blades 130. The hollow shaft 120 is sized to receive and be detachably coupled to the spindle 160 so that the spindle 160 can drive the shaft 120. The annular support members 150 are arranged in pairs, which sandwich corresponding annular blades 130 to provide lateral support to the blades 130. The support members 150 have a thickness S₁ and include a surface 152 juxtaposed to a side surface 140 of the corresponding blade 130. The blade assembly 110 can further include a plurality of spacers 158 carried by the shaft 120 between adjacent pairs of support members 150. The spacers 158 can have a length S₂ sized so that the spacer 158 and the support members 150 separate adjacent blades 130 by a desired distance, which may correspond to the spacing between microfeature devices on a microfeature workpiece. In other embodiments, the blade assembly 110 may not include a pair of support members 150 for each blade 130 and/or spacers 158 between blades 130. In additional embodiments, the blade assembly 110 may include washers between the support members 150 and the blades 130.

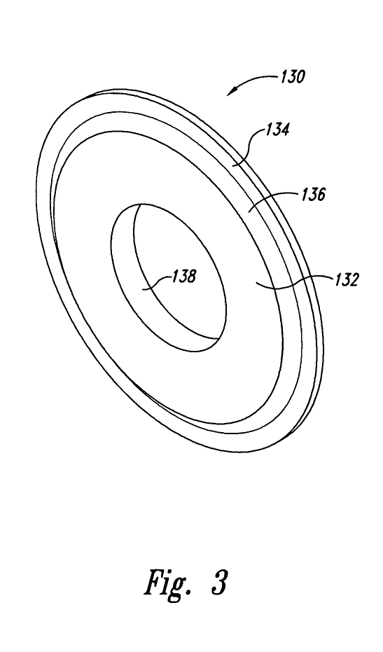

FIG. 3 is an isometric view of one of the annular blades 130 of FIG. 2. Referring to FIGS. 2 and 3 together, the individual annular blades 130 include an inner portion 132, an outer portion 134 radially outward of the inner portion 132, and an intermediate portion 136 between the inner and outer portions 132 and 134. The inner portion 132 can include a hole 138 sized to receive the shaft 120 (FIG. 2). Referring only to FIG. 2, the illustrated inner portion 132 has a first thickness T₁, and the illustrated outer portion 134 has a second thickness T₂ less than the first thickness T₁. The ratio of the first thickness T₁ to the second thickness T₂ can be 2:1, 5:1, 10:1, 20:1, or another suitable ratio.

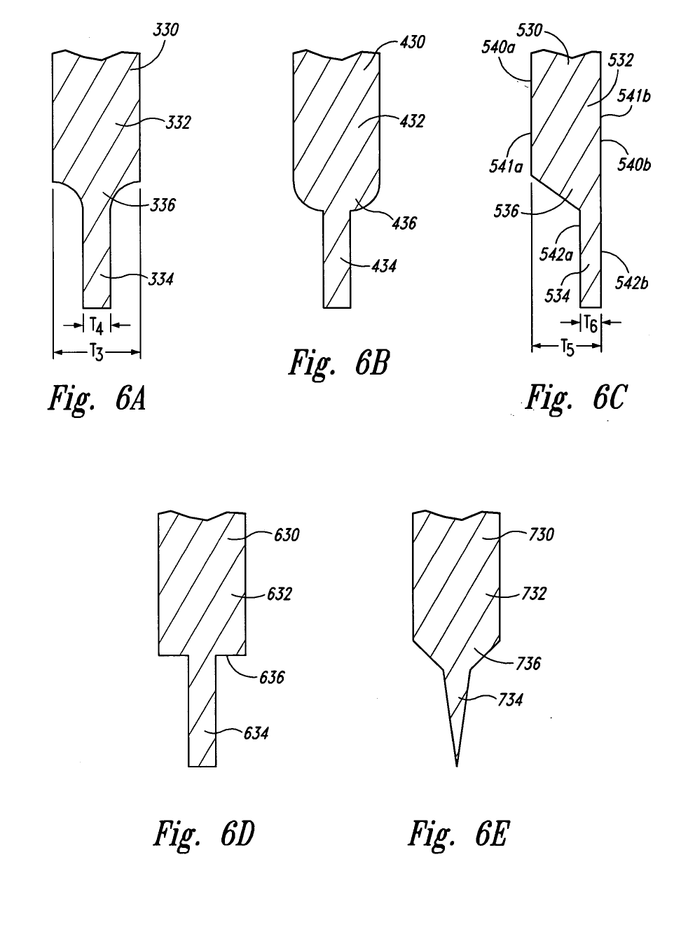

The second thickness T₂ of the outer portion 134 can be sized to cut a microfeature workpiece between adjacent microfeature devices to singulate the devices while limiting the kerf in the workpiece. For example, the second thickness T₂ can be from approximately 260 microns to approximately 300 microns. In other embodiments, however, the second thickness T₂ can be less than 260 microns or greater than 300 microns. Although in the illustrated embodiment the inner and outer portions 132 and 134 each have generally uniform thicknesses, in additional embodiments, the inner and/or outer portion may have a nonuniform thickness. For example, in the embodiment described below with reference to FIG. 6E, the outer portion is tapered.

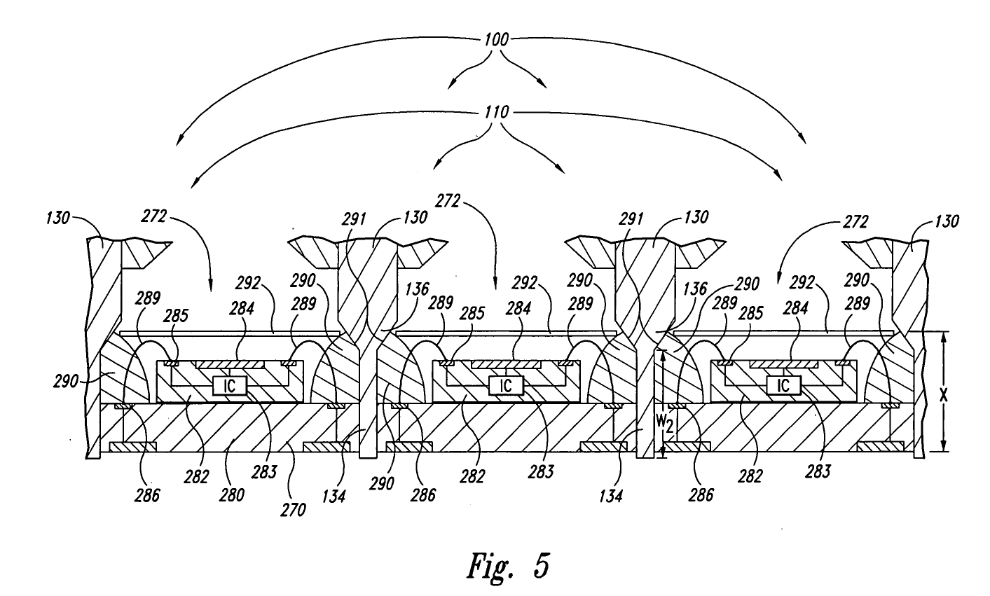

The illustrated intermediate portion 136 is a beveled portion having the first thickness T₁ at a first diameter D₁ and the second thickness T₂ at a second diameter D₂. As such, the side surfaces 140 of the blades 130 include an interior region 142 and a perimeter region 144 noncoplanar with the interior region 142. The intermediate portion 136 can be shaped and sized to form a desired corresponding feature in a microfeature workpiece, as described below with reference to FIG. 5. In other embodiments, such as those described below with reference to FIGS. 6A-6E, the intermediate portion 136 may not be beveled but can have other configurations.

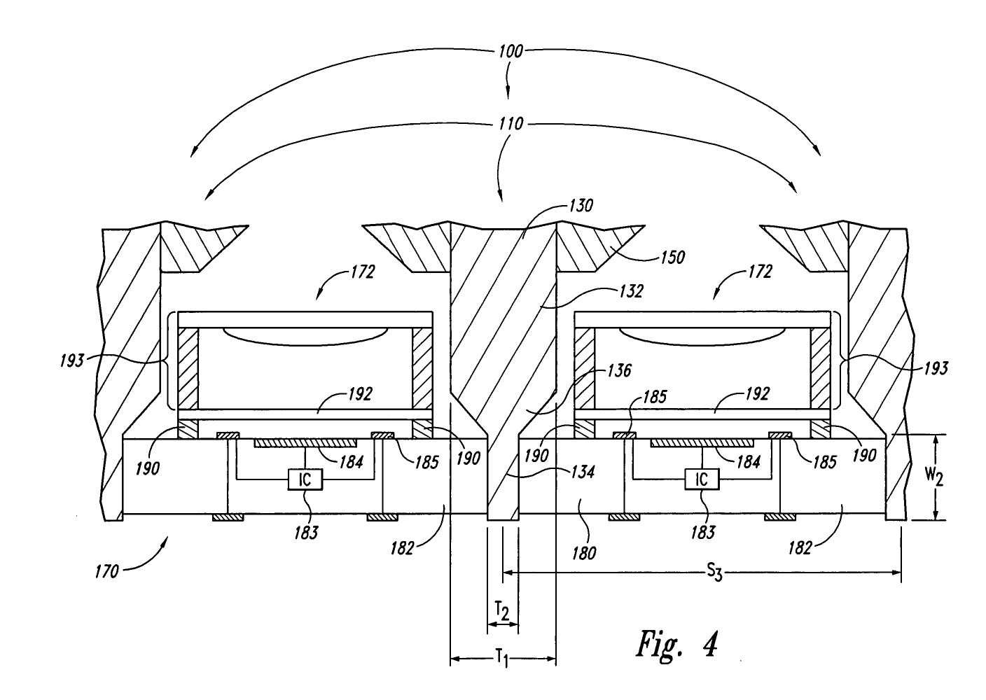

The outer portion 134 and the intermediate portion 136 can be sized and configured based on the dimensions of a microfeature workpiece. For example, the difference between an outer diameter D₃ of the individual blades 130 and the second diameter D₂ can correspond to a thickness of the microfeature workpiece. More specifically, a width W₂ of the outer portion 134 can be approximately equal to the thickness of the microfeature workpiece such that only the outer portion 134 cuts the workpiece, as described with reference to FIG. 4. Alternatively, the width W₂ of the outer portion 134 can be less than the thickness of the microfeature workpiece such that the outer and intermediate portions 134 and 136 cut the workpiece, as described with reference to FIG. 5. In other embodiments, however, the width W₂ of the outer portion 134 can be greater than the thickness of the microfeature workpiece.

FIG. 4 is a schematic side cross-sectional view of the saw 100 cutting a microfeature workpiece 170. In this embodiment, the microfeature workpiece 170 includes a plurality of imagers 172 formed in and/or on a substrate 180. The individual imagers 172 include a die 182 having an integrated circuit 183 (shown schematically), an image sensor 184 operably coupled to the integrated circuit 183, and an array of bond-pads 185 electrically coupled to the integrated circuit 183. The image sensor 184 can be a CMOS device or CCD for capturing pictures or other images in the visible spectrum. The individual imagers 172 can further include a spacer 190, a cover 192 mounted to the spacer 190 to form an enclosure for protecting the image sensor 184, and an optics unit 193 to transmit the desired spectrum of radiation to the image sensor 184. In other embodiments, the microfeature workpiece 170 can have other configurations.

As shown in FIG. 4, the illustrated saw 100 can cut the microfeature workpiece 170 to singulate the individual imagers 172 by rotating the individual blades 130 about the axis A₁ (FIG. 2) while moving the blade assembly 110 across the workpiece 170. The support members 150 and spacers 158 (FIG. 2) are sized such that the outer portions 134 of adjacent blades 130 are spaced apart by a distance S₃ that corresponds to the spacing of the imagers 172 on the workpiece 170 so that the blade assembly 110 can singulate the imagers 172. Moreover, in this embodiment, the width W₂ of the outer portion 134 of the blades 130 is sized such that only the outer portion 134 cuts the microfeature workpiece 170, and the first thickness T₁ of the inner portion 132 is sized to fit between adjacent imagers 172. Accordingly, as the outer portion 134 of the blades 130 cuts the microfeature workpiece 170, the inner and intermediate portions 132 and 136 move between adjacent imagers 172. In additional embodiments, such as the embodiment described below with reference to FIG. 5, the intermediate portion 136 and/or the inner portion 132 can also cut or otherwise form features in the workpiece.

One feature of the blades 130 illustrated in FIGS. 2-4 is that the first thickness T₁ of the inner portion 132 is greater than the second thickness T₂ of the outer portion 134. Another feature of the blades 130 is that the inner portion 132 is sized to fit between adjacent imagers 172 in order to reduce the width W₂ of the outer portion 134. An advantage of these features is that the larger first thickness T₁ of the inner portion 132 and reduced width W₂ of the outer portion 134 increase the strength and rigidity of the blade 130 without increasing the kerf in the microfeature workpiece 170. Because the illustrated blades 130 are stronger and more rigid, the blades 130 are less likely to break and/or wobble while singulating imagers or other devices.

FIG. 5 is a schematic side cross-sectional view of the saw 100 cutting a microfeature workpiece 270 to singulate a plurality of microfeature devices 272 and form features in the devices 272. The illustrated microfeature workpiece 270 includes a support member 280 and a plurality of dies 282 arranged in an array on the support member 280. The illustrated dies 282 include an integrated circuit 283 (shown schematically), an image sensor 284 operably coupled to the integrated circuit 283, and a plurality of bond-pads 285 electrically coupled to the integrated circuit 283. A plurality of wire-bonds 289 electrically couple the bond-pads 285 to corresponding contacts 286 on the support member 280. The illustrated individual microfeature devices 272 further include a barrier 290 circumscribing the die 282 and a radiation transmissive window 292 attached to the barrier 290.

As shown in FIG. 5, the illustrated saw 100 can cut the microfeature workpiece 270 to singulate the microfeature devices 272 by rotating the individual blades 130 about the axis A₁ (FIG. 2) and moving the blade assembly 110 across the workpiece 270. In this embodiment, the width W₂ of the outer portion 134 is less than a thickness X of the workpiece 270 such that the outer and intermediate portions 134 and 136 of the blades 130 cut the workpiece 270. As such, the beveled intermediate portion 136 forms a chamfer 291 in the barrier 290 as it cuts the workpiece 270. In other embodiments, such as those described below with reference to FIGS. 6A-6E, the intermediate portion 136 can have different configurations and form other features in the microfeature devices 272. An advantage of this aspect of the illustrated blades 130 is that the features can be formed on the microfeature devices 272 for aesthetic purposes or to create space for other components when the devices 272 are used in electronic devices.

C. Additional Embodiments of Blades for Cutting Microfeature Workpieces

FIGS. 6A-6E illustrate various configurations of annular blades in accordance with additional embodiments of the invention. For example, FIG. 6A is a schematic side cross-sectional view of a section of an annular blade 330 having an inner portion 332, an outer portion 334, and an intermediate portion 336 between the inner and outer portions 332 and 334. The inner portion 332 has a first thickness T₃ and the outer portion 334 has a second thickness T₄ less than the first thickness T₃. The illustrated intermediate portion 336 has a concave configuration shaped to form a corresponding feature on a microfeature workpiece.

FIG. 6B is a schematic side cross-sectional view of a section of an annular blade 430 in accordance with another embodiment of the invention. The illustrated blade 430 includes an inner portion 432, an outer portion 434, and an intermediate portion 436 between the inner and outer portions 432 and 434. The intermediate portion 436 has a convex configuration shaped to form a corresponding feature on a microfeature workpiece.

FIG. 6C is a schematic side cross-sectional view of a section of an annular blade 530 in accordance with another embodiment of the invention. The illustrated blade 530 includes an inner portion 532, an outer portion 534, a beveled intermediate portion 536 between the inner and outer portions 532 and 534, a first side surface 540a, and a second side surface 540b opposite the first side surface 540a. The inner portion 532 has a first thickness T₅ and the outer portion 534 has a second thickness T₆ less than the first thickness T₅. The first side surface 540a includes an interior region 541a and a perimeter region 542a radially outward and noncoplanar with the interior region 541a. The second side surface 540b includes an interior region 541b and a perimeter region 542b radially outward and generally coplanar with the interior region 541b.

FIG. 6D is a schematic side cross-sectional view of a section of an annular blade 630 in accordance with another embodiment of the invention. The illustrated blade 630 includes an inner portion 632, an outer portion 634, and an intermediate portion 636 between the inner and outer portions 632 and 634. The illustrated intermediate portion 636 includes a step-down portion.

FIG. 6E is a schematic side cross-sectional view of a section of an annular blade 730 in accordance with another embodiment of the invention. The illustrated blade 730 includes an inner portion 732, an outer portion 734, and an intermediate portion 736 between the inner and outer portions 732 and 734. The illustrated intermediate portion 736 includes a beveled portion, and the illustrated outer portion 734 includes a tapered portion. In additional embodiments, the blade 730 may not include an intermediate portion and the tapered outer portion 734 can project from the inner portion 732.

From the foregoing, it will be appreciated that specific embodiments of the invention have been described herein for purposes of illustration, but that various modifications may be made without deviating from the spirit and scope of the invention. For example, many of the features of one embodiment can be combined with other embodiments in addition to or in lieu of the features of the other embodiments. Accordingly, the invention is not limited except as by the appended claims.

I claim:

1. A saw for cutting a microfeature workpiece, the saw comprising:
a shaft for attachment to a spindle;
an annular blade coupled to the shaft, the blade having a first thickness at a first diameter and a second thickness at a second diameter, the second thickness being different than the first thickness and sized to cut the microfeature workpiece; and
a support member coupled to the shaft and juxtaposed to the annular blade.

2. The saw of claim 1 wherein:
the annular blade is a first annular blade having a perimeter portion;
the saw further comprises a second annular blade coupled to the shaft, the second annular blade having a perimeter portion, a first thickness at a first diameter, and a second thickness at a second diameter, the second thickness being different than the first thickness; and
the perimeter portions of the first and second annular blades are spaced apart a distance corresponding to the spacing of microfeature devices on the microfeature workpiece.

3. The saw of claim 1 wherein the annular blade further includes a beveled portion between the first and second diameters.

4. The saw of claim 1 wherein the annular blade further includes a convex portion between the first and second diameters.

5. The saw of claim 1 wherein the annular blade further includes a concave portion between the first and second diameters.

6. The saw of claim 1 wherein the annular blade further includes a step-down portion between the first and second diameters.

7. The saw of claim 1 wherein the annular blade further includes an intermediate portion between the first and second diameters, the intermediate portion configured to form a corresponding feature in the microfeature workpiece.

8. The saw of claim 1 wherein:
the annular blade further includes an inner portion having the first thickness and a perimeter portion having the second thickness; and
the first thickness is greater than the second thickness.

9. The saw of claim 1 wherein:
the support member has an outer diameter;
the second diameter of the blade is greater than the first diameter; and
the first diameter of the blade is greater than the outer diameter of the support member.

10. The saw of claim 1 wherein the blade further includes a tapered perimeter portion.

11. The saw of claim 1 wherein the blade further includes an inner portion having the first thickness and a perimeter portion having the second thickness, an outer diameter, and an inner diameter, and wherein the difference between the outer diameter and the inner diameter corresponds with a thickness of the microfeature workpiece.

12. The saw of claim 1, further comprising:
the spindle carrying the shaft; and
a motor operably coupled to the spindle.

13. The saw of claim 1 wherein:
the second diameter is greater than the first diameter; and
the first thickness is at least twice the second thickness.

14. An annular blade for cutting a microfeature workpiece having a first microfeature device and a second microfeature device adjacent to the first microfeature device, the blade comprising an inner portion, an outer portion radially outward of the inner portion, and an intermediate portion between the inner and outer portions, the inner portion having a generally uniform first thickness and the outer portion having a second thickness less than the first thickness, the second thickness being sized to cut the microfeature workpiece between the first and second microfeature devices.

15. The blade of claim 14 wherein the intermediate portion includes a beveled portion.

16. The blade of claim 14 wherein the intermediate portion includes a convex portion.

17. The blade of claim 14 wherein the intermediate portion includes a concave portion.

18. The blade of claim 14 wherein the intermediate portion includes a step-down portion.

19. The blade of claim 14 wherein the intermediate portion is configured to form a corresponding feature in the microfeature workpiece.

20. The blade of claim 14 wherein the outer portion includes a tapered perimeter portion.

21. The blade of claim 14 wherein the outer portion has an outer diameter and an inner diameter, and wherein the difference between the outer diameter and the inner diameter corresponds with a thickness of the microfeature workpiece.

22. The blade of claim 14 wherein the first thickness is at least twice the second thickness.

23. A blade assembly for cutting a microfeature workpiece, the blade assembly comprising:
a shaft for attachment to a spindle;
a blade carried by the shaft, the blade having a first side surface and a second side surface opposite the first side surface, the first side surface having an interior region and a perimeter region noncoplanar with the interior region, the second side surface having an interior region and a perimeter region noncoplanar with the interior region, the blade being sized to cut the microfeature workpiece; and
a support member carried by the shaft and juxtaposed to the blade.

24. The blade assembly of claim 23, further comprising a second blade carried by the shaft, the second blade having a first side surface and a second side surface opposite the first side surface, the first side surface having an interior region and a perimeter region noncoplanar with the interior region, the second side surface having an interior region and a perimeter region noncoplanar with the interior region.

25. The blade assembly of claim 23 wherein the blade further includes a beveled portion.

26. The blade assembly of claim 23 wherein the blade further includes an inner portion having a first thickness and an outer portion having a second thickness less than the first thickness.

27. The blade assembly of claim 23 wherein the blade further includes an inner portion and a perimeter portion radially outward of the inner portion, the inner portion having a first thickness and the perimeter portion having a second thickness, an outer diameter, and an inner diameter, wherein the first thickness is greater than the second thickness, and wherein the difference between the outer diameter and the inner diameter corresponds with a thickness of the microfeature workpiece.

28. A blade assembly for cutting a microfeature workpiece, the blade assembly comprising:
a shaft for attachment to a spindle;
a first blade coupled to the shaft, the first blade having a first portion and a second portion radially outward of the first portion, the first portion having a first thickness and the second portion having a second thickness different than the first thickness; and
a second blade coupled to the shaft and spaced apart from the first blade, the second blade having a first portion and a second portion radially outward of the first portion, the first portion having a first thickness and the second portion having a second thickness different than the first thickness.

29. The blade assembly of claim 28 wherein the first and second blades are spaced apart by a distance corresponding to the spacing of microfeature devices on the microfeature workpiece.

30. The blade assembly of claim 28 wherein the first and second blades further include a beveled portion between the first and second portions.

31. The blade assembly of claim 28 wherein the first and second blades further include an intermediate portion between the first and second portions, the intermediate portion configured to form a corresponding feature in the microfeature workpiece.

32. The blade assembly of claim 28 wherein the first thickness of the first and second blades is greater than the second thickness.

33. The blade assembly of claim 28 wherein the second portion of the first and second blades has an outer diameter and an inner diameter, and wherein the difference between the outer diameter and the inner diameter corresponds with a thickness of the microfeature workpiece.

34. A saw for cutting a microfeature workpiece, the saw comprising:
a shaft for attachment to a spindle;
an annular blade coupled to the shaft, the blade having a first portion for cutting the microfeature workpiece and a second portion for forming a corresponding feature in the microfeature workpiece; and
a support member coupled to the shaft and juxtaposed to the annular blade.

35. The saw of claim 34 wherein the second portion of the annular blade is radially inward of the first portion.

36. The saw of claim 34 wherein the first portion has a first thickness and the second portion has a second thickness greater than the first thickness.

37. A saw for cutting a microfeature workpiece, the saw comprising:
a shaft for attachment to a spindle;
a means for cutting and forming a feature in the microfeature workpiece, the means for cutting and forming being coupled to the shaft; and
a support member coupled to the shaft and juxtaposed to the means for cutting and forming.

38. The saw of claim 37 wherein the means for cutting and forming comprises an annular blade having an inner portion with a first thickness and an outer portion with a second thickness less than the first thickness.

39. The saw of claim 37 wherein the means for cutting and forming comprises an annular blade having an inner portion, an intermediate portion, and a perimeter portion, and wherein the inner portion has a first thickness, the perimeter portion has a second thickness less than the first thickness, and the intermediate portion is configured to form the feature in the workpiece.

40. A method for cutting a microfeature workpiece, the method comprising:
providing an annular blade having a first thickness at a first diameter and a second thickness at a second diameter, the second thickness being different than the first thickness; and
moving the annular blade across the microfeature workpiece to cut the workpiece.

41. The method of claim 40 wherein:
the annular blade further includes an inner portion having the first thickness and an outer portion having the second thickness;
the first thickness is greater than the second thickness; and
moving the annular blade comprises cutting the microfeature workpiece with the outer portion of the blade.

42. The method of claim 40 wherein:
the annular blade further includes an inner portion having the first thickness and an outer portion having the second thickness, an inner diameter, and an outer diameter;
the difference between the inner and outer diameters of the outer portion corresponds with a thickness of the microfeature workpiece;
the first thickness is greater than the second thickness; and
moving the annular blade comprises cutting the microfeature workpiece with the outer portion of the blade.

43. The method of claim 40 wherein:
the annular blade further includes an inner portion having the first thickness, an outer portion having the second thickness, and an intermediate portion between the first and second portions;
the first thickness is greater than the second thickness; and
moving the annular blade comprises forming a corresponding feature in the microfeature workpiece with the intermediate portion of the blade.

44. The method of claim 40 wherein the annular blade is a first annular blade, and wherein the method further comprises:
providing a second annular blade having a first thickness at a first diameter and a second thickness at a second diameter, the second thickness being different than the first thickness; and
moving the second annular blade across the microfeature workpiece to cut the workpiece while moving the first annular blade across the workpiece.

45. The method of claim 40 wherein moving the annular blade comprises singulating a plurality of microfeature devices on the microfeature workpiece.

46. The method of claim 40 wherein:
the annular blade further includes an inner portion having the first thickness, an outer portion having the second thickness, and a beveled portion between the inner and outer portions;
the first thickness is greater than the second thickness; and
moving the annular blade comprises cutting the microfeature workpiece with the outer portion and/or the beveled portion of the blade.

47. A method for cutting a microfeature workpiece, the method comprising:
providing a blade having a first surface and a second surface opposite the first surface, the first surface having an interior region and a perimeter region noncoplanar with the interior region, and the second surface having an interior region and a perimeter region noncoplanar with the interior region; and
moving the blade relative to the microfeature workpiece to cut the workpiece.

48. The method of claim 47 wherein:
the blade further includes an inner portion having a first thickness and an outer portion having a second thickness less than the first thickness; and
moving the blade comprises cutting the microfeature workpiece with the outer portion of the blade.

49. The method of claim 47 wherein:
the blade further includes an inner portion having a first thickness and an outer portion having a second thickness, an inner diameter, and an outer diameter;
the first thickness is greater than the second thickness;
the difference between the inner and outer diameters of the outer portion corresponds with a thickness of the microfeature workpiece; and
moving the blade comprises cutting the microfeature workpiece with the outer portion of the blade.

50. The method of claim 47 wherein:
the blade further includes an inner portion having a first thickness, an outer portion having a second thickness, and an intermediate portion between the first and second portions;
the first thickness is greater than the second thickness; and
moving the blade comprises forming a corresponding feature in the microfeature workpiece with the intermediate portion of the blade.

51. The method of claim 47 wherein the blade is a first blade, and wherein the method further comprises:
providing a second blade having a first surface and a second surface opposite the first surface, the first surface having an interior region and a perimeter region noncoplanar with the interior region, and the second surface having an interior region and a perimeter region noncoplanar with the interior region; and
moving the second blade across the microfeature workpiece to cut the workpiece while moving the first blade across the workpiece.

52. A method for cutting a microfeature workpiece having a plurality of microfeature devices, the method comprising:
providing a shaft and a plurality of blades coupled to the shaft, the blades having an interior portion with a first thickness and a perimeter portion with a second thickness less than the first thickness; and
cutting the microfeature workpiece with the blades to singulate the microfeature devices.

53. The method of claim 52 wherein cutting the microfeature workpiece comprises cutting the workpiece with the perimeter portion of the blades.

54. The method of claim 52 wherein:
the perimeter portion of the blades has an inner diameter and an outer diameter;
the difference between the inner and outer diameters of the perimeter portion corresponds with a thickness of the microfeature workpiece; and
cutting the microfeature workpiece comprises cutting the microfeature workpiece with the perimeter portion of the blades.

55. The method of claim 52 wherein:
the blades further include an intermediate portion between the interior and perimeter portions; and
cutting the microfeature workpiece comprises forming features in the microfeature workpiece with the corresponding intermediate portions.

56. A method of cutting a microfeature workpiece, the method comprising:
contacting the workpiece with a first portion of an annular blade, the first portion having a first thickness; and
contacting the workpiece with a second portion of the annular blade, the second portion being radially inward of the first portion, and the second portion having a second thickness greater than the first thickness.

57. The method of claim 56 wherein:
contacting the workpiece with the first portion comprises cutting the workpiece; and
contacting the workpiece with the second portion comprises forming a corresponding feature in the workpiece.

58. A method of manufacturing a saw for cutting a microfeature workpiece, the method comprising:
forming a plurality of annular blades having an inner portion with a first thickness and a perimeter portion with a second thickness less than the first thickness; and
coupling the annular blades to a shaft with the individual blades spaced apart by a desired distance.

59. The method of claim 58 wherein forming the annular blades comprises forming a beveled portion between the inner and perimeter portions.

60. The method of claim 58 wherein forming the annular blades comprises forming a convex portion between the inner and perimeter portions.

61. The method of claim 58 wherein forming the annular blades comprises forming a concave portion between the inner and perimeter portions.

62. The method of claim 58 wherein forming the annular blades comprises forming a step-down portion between the inner and perimeter portions.

63. The method of claim 58 wherein forming the annular blades comprises forming an intermediate portion between the inner and perimeter portions, the intermediate portion configured to form a corresponding feature in the microfeature workpiece.

64. The method of claim 58 wherein forming the annular blades comprises forming the annular blades with the first thickness being at least twice the second thickness.

65. The method of claim 58 wherein:
the perimeter portion of the blades includes an outer diameter and an inner diameter; and
forming the annular blades comprises forming the perimeter portion of the blades so that the difference between the inner and outer diameters corresponds with a thickness of the microfeature workpiece.

66. The method of claim 58 wherein coupling the annular blades to the shaft comprises spacing the blades apart by a distance corresponding to the spacing of microfeature devices on the microfeature workpiece.
